(19) United States
(12) Patent Application Publication
(10) Pub. No.: US 2005/0105820 A1
(43) Pub. Date: May 19, 2005

(54) Method for enhancing monochrome text image

(76) Inventors: Xing-Ping Zhou, Beijing (CN); Yan-Ru Jiang, Beijing (CN)

Correspondence Address: RABIN & BERDO, P.C.;Suite 500, 1101 14th Street, N.W., Washington, DC, 20005, US

(21) Appl. No.: 10/714,964

(22) Filed: Nov. 18, 2003

(51) Int. Cl. G06K 9/40; G06K 9/34

(52) U.S. Cl. 382/266; 382/176

(57) ABSTRACT

A method for enhancing text image is applicable to a digital image containing monochrome text. The method is first to label text pixels and to-be-determined pixels according to grayscales of the image pixels. Then, to identify some mostly-be text pixels, smooth them into text pixels; and look for text edge pixels from the rest of the to-be-determined pixels, and fill the text pixels to enhance contrast of text and background. The zigzags are thus removed and the text clearness is improved.

### BACKGROUND OF THE INVENTION

1. Field of the Invention

The invention generally relates to a method of digital image processing, and in particular relates to a method for enhancing monochrome text in a digital image.

2. Related Art

In accompany with widely used digital products, digital images appear more and more frequently in our daily lives. To process digital image becomes a necessary ability of some people. Digital images are processed in many ways. Mostly, digital images are processed as pictures. However, some parts of digital images are texts, and mostly of single color. The monochrome texts require a specific processing method, instead of common full-color image process.

A common problem of monochrome text is the unclearness of text image. For example, after copying, printing or scanning, the edge of text is unclear. An original black text is obtained as a gray one because of ink penetration or scanning deviation. The edge of a scanned text is obscure. The inner portion of the text is about 60 to 70% grayscale. The edge of the text turns from 60˜70% to 30˜40% grayscale, and further dims to less than 10% light gray. Therefore, the edge of the text zigzags and requires a suitable image process to improve its clearness. For general picture image, some processes of image enhancement and edge extraction can improve the clearness of image. However, these common image processes are for processing complicated colorful image and are helpless to monochrome text. Currently, there is no specific method for processing text image, removing zigzags and improving clearness of text.

### SUMMARY OF THE INVENTION

The object of the invention is to provide a method for enhancing text image. The method of the invention is applicable to monochrome text image. By extracting the edge of the text and filling pixels to the text, the zigzags are removed and the text clearness are improved.

A method for enhancing monochrome text image according to the invention is first to label text pixels and to-be-determined pixels. Then, to identify some mostly-be text pixels, smooth them into text pixels; and to search text edge pixels from the rest of the to-be-determined pixels, and fill the text pixels.

The monochrome text enhancement method of the invention sharpens the text edge and improves the clearness of the text by smoothing the text pixels, extracting the text edge and filling the text and background pixels. The process of the invention is fast, accurate and efficient.

### BRIEF DESCRIPTION OF THE DRAWINGS

The invention will become more fully understood from the detailed description given here in below. However, this description is for purposes of illustration only, and thus is not limitative of the invention, wherein:

FIG. 1 is an operational flowchart of a monochrome text enhancement method of the invention;

FIG. 2 is a flowchart of smoothing the mostly-be text pixels in the process of the invention;

FIG. 3 is a flowchart of extracting text edge from the current to-be-determined pixels in the process of the invention;

FIG. 4 is a flowchart of checking continuous adjacent pixels in the process of the invention;

FIGS. 5a to 5d are explanatory examples of smoothing mostly-be text pixels in the process of the invention;

FIG. 6 is an explanatory view of continuous adjacent pixels in different directions according to the invention; and

FIGS. 7a to 7f are sequential change of grayscale of an image example processed with the method of the invention.

### DETAILED DESCRIPTION OF THE INVENTION

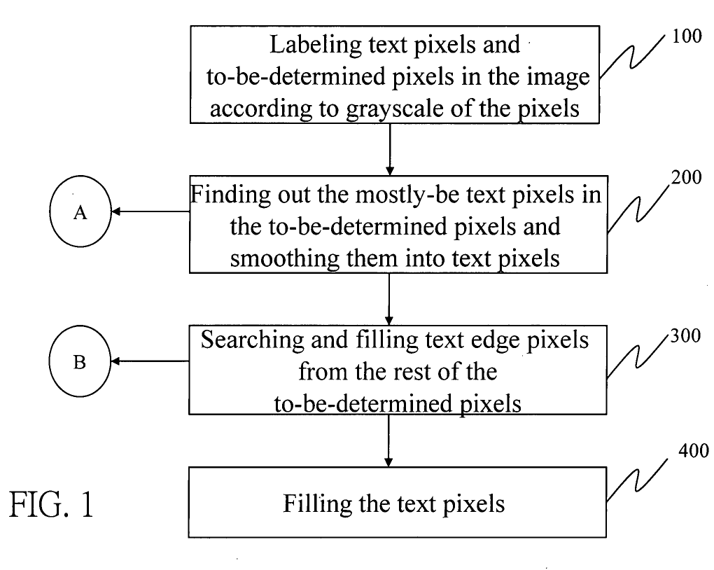

The invention provides a monochrome text image enhancement method applicable to digital images that include text image of single color. As shown in FIG. 1, a method for enhancing monochrome text image has the following steps.

First, labeling text pixels and to-be-determined pixels in the image according to grayscale of the pixels (step 100). Finding out the mostly-be text pixels in the to-be-determined pixels and smoothing them into text pixels (step 200). Searching and filling text edge pixels from the rest of the to-be-determined pixels (step 300). Finally, filling the text pixels (step 400).

The method of the invention will be further described with an example of black text on white background as follows. The scanned text image usually has obscure edge and gray text areas. The monochrome text image enhancement method of the invention can solve the problem and improve the clearness of the text. First, scanning the image to get the grayscale of each pixel. Labeling text pixels and to-be-determined pixels in the image according to grayscale of the pixels. The text pixels are those having grayscale smaller than a threshold T1. The to-be-determined pixels are the rest. The threshold T1 in the example is 0×70. Afterwards, some mostly-be text pixels in the to-be-determined pixels will be found out and smoothed into text pixels.

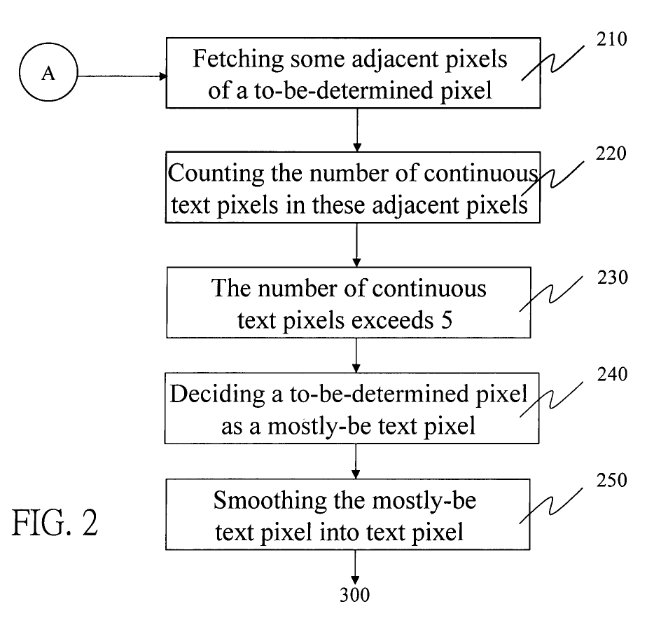

FIG. 2 is a flowchart of smoothing the mostly-be text pixels in the process of the invention. First, fetching some adjacent pixels of a to-be-determined pixel (step 210), and counting the number of continuous text pixels in these adjacent pixels (step 220). Deciding a to-be-determined pixel as a mostly-be text pixel (step 240) when the number of continuous text pixels exceeds 5 (step 230). The so-called adjacent pixels are the nearest pixels surrounding the to-be-determined pixel in eight directions. Then, smoothing the mostly-be text pixel into text pixel (step 250).

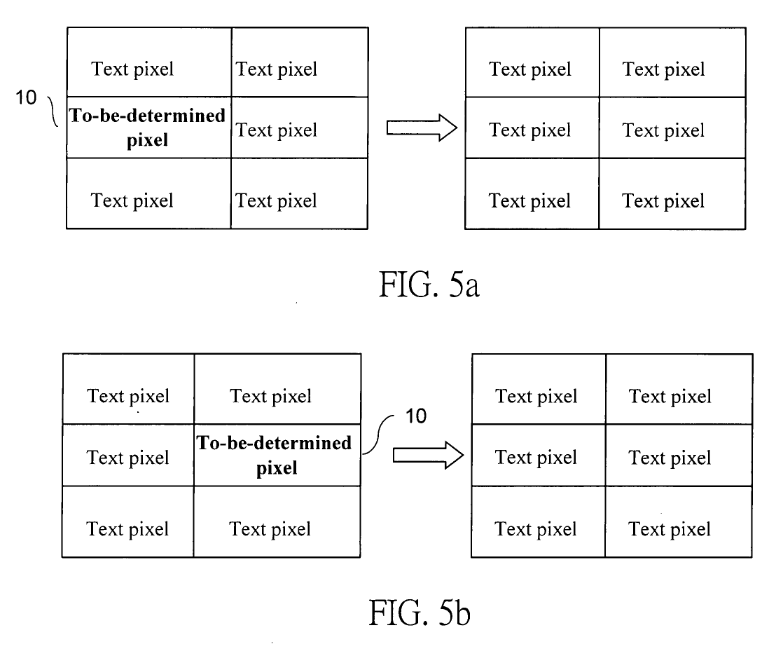

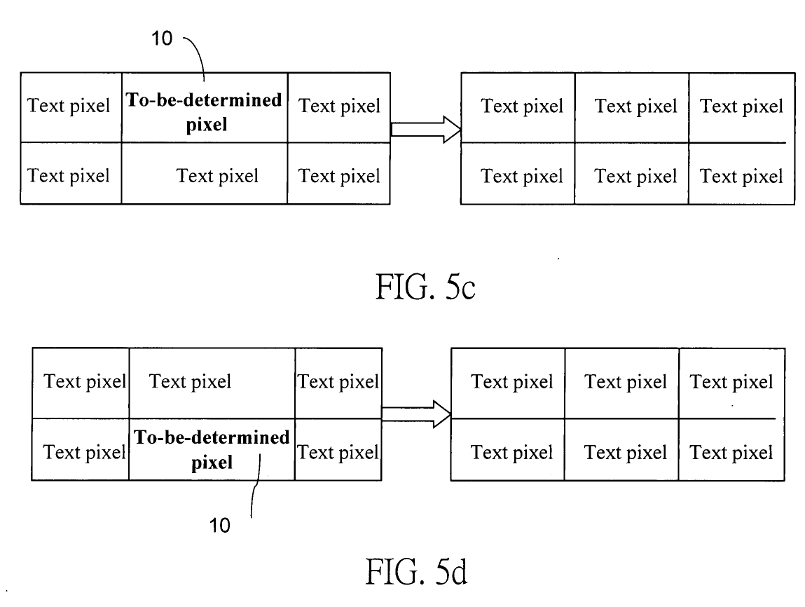

The mostly-be text pixels are those pixels having at least 5 continuous surrounding text pixels. A mostly-be text pixel can be smoothed in horizontal direction or vertical direction as shown in FIGS. 5a to 5d. In the drawings, the mostly-be text pixels 10 have 5 continuous surrounding text pixels. The mostly-be text pixels 10 in FIGS. 5a and 5b are smoothed horizontally. The mostly-be text pixels 10 in FIGS. 5c and 5d are smoothed vertically.

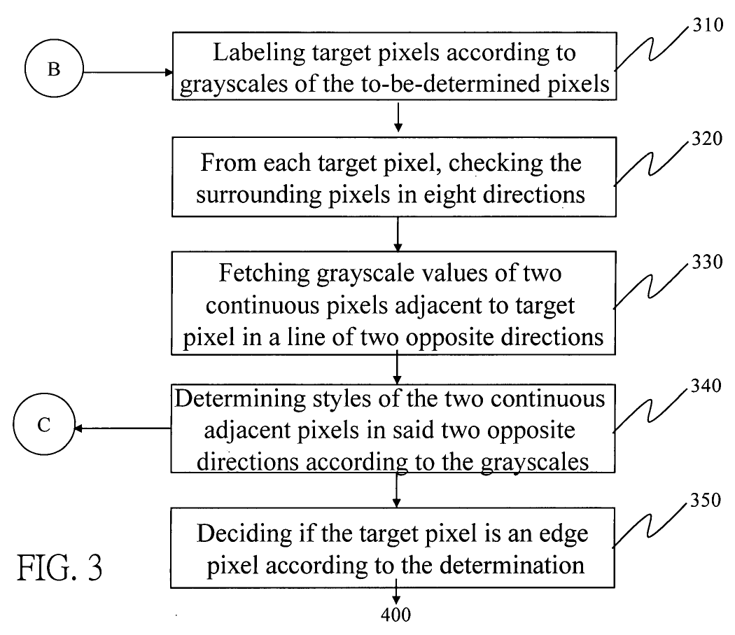

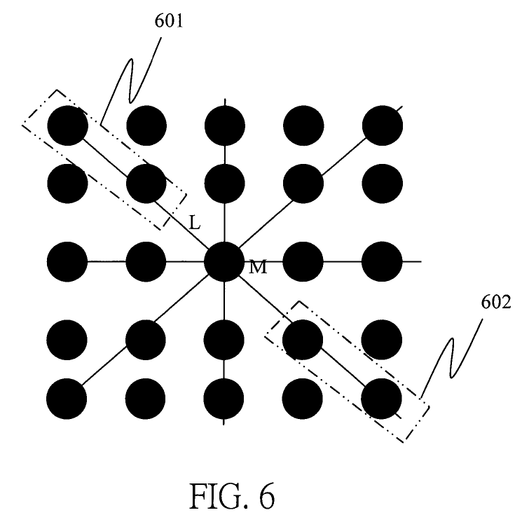

After smoothing the mostly-be text pixels, some text edge pixels are searched from the rest of the to-be-determined pixels. The process of searching text edge pixels from the rest of the to-be-determined pixels is shown in FIG. 3. Some target pixels are labeled according to the grayscale of the to-be-determined pixels (step 310). The target pixels are those pixels having grayscales located between a lower value T3 and a higher value T4. The grayscales T3 and T4 are two predetermined values, for example, T3=0×70 and T4=0×B0. From each target pixel, checking the surrounding pixels in eight directions (step 320). As shown in FIG. 6, for a target pixel M, there are eight-direction lines, i.e., four lines each with two directions, extending from the target pixel. Checking the grayscale values of two pixels (or more pixels) along each direction (step 330). For example, in the drawing, along two directions of the line L, there are continuous pixels 601 and 602 to be checked of their grayscales. Then determine styles of said two continuous adjacent pixels in said two opposite directions according to said grayscales (step 340).

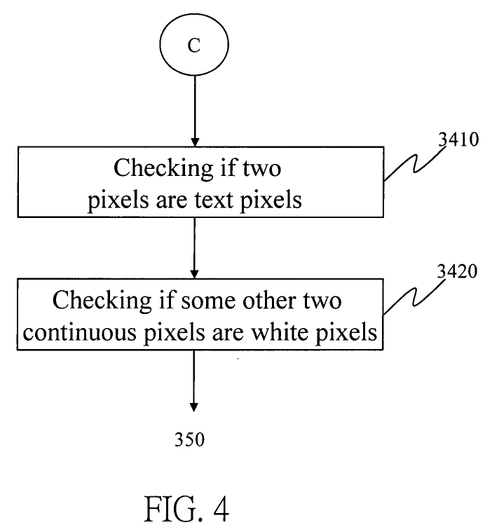

The process of checking the grayscales of continuous pixels and determining the edge pixel is shown in FIG. 4. First, checking if two continuous pixels are text pixels (step 3410). Then, checking if other two continuous pixels are white (background) pixels (step 3420). When two continuous pixels adjacent to a target pixel are text pixels (with grayscale lower than a threshold T1), and other two continuous pixels on the opposite side along the line are white pixels, then the target pixel is an edge pixel. The white pixels are those having grayscale values larger than a second threshold T2, for example, T2=0×C0.

According to the results, labeling some specific target pixel as edge pixels (step 350). Then filling the edge pixels as text pixels or background pixels. Finally, filling all the text pixels, and filling the rest to-be-determined pixels as background pixels and finishing the process.

In the aforesaid step of filling the edge pixels, if all the edge pixels are filled as text pixels, the text may become too thick. On the contrary, if all the edge pixels are filled as background pixels, the text may become too thin. Therefore, in order to keep the text of suitable thickness, it is preferred to fill the left-side edge pixels as text pixels and fill the right-side edge pixels as background pixels; or fill the right-side edge pixels as text pixels and fill the left-side edge pixels as background pixels.

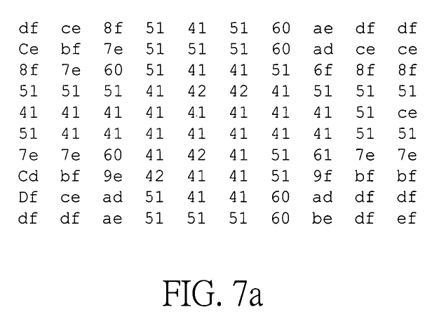

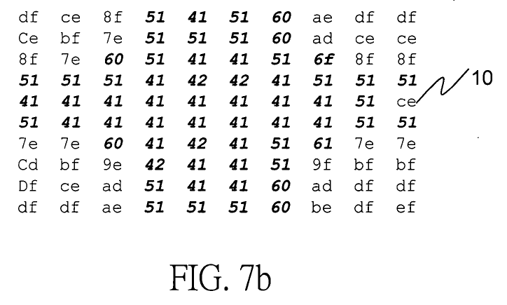

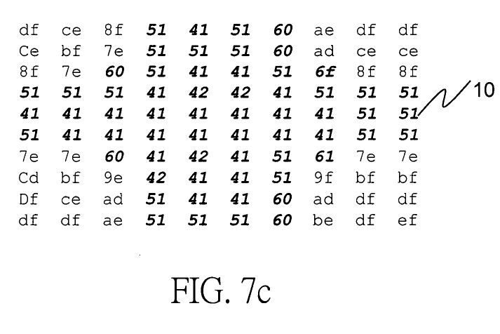

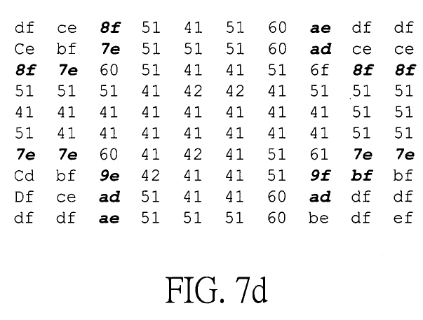

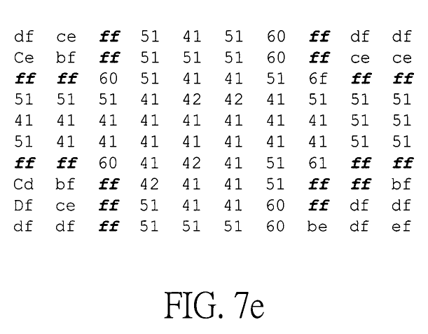

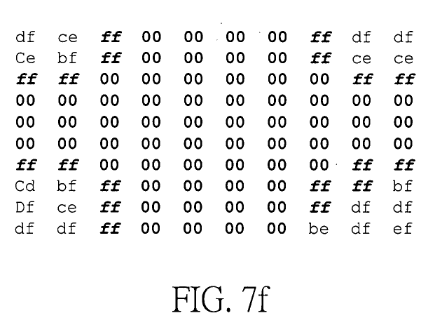

FIGS. 7a to 7f are sequential grayscale diagrams of an example of text image processed with the method of the invention. FIG. 7a is the grayscale diagram of an original image after being scanned. FIG. 7b is the grayscale diagram being labeled as text pixels and to-be-determined pixels, in which the bold label pixels are text pixels that have grayscales less than a threshold T1; the others are to-be-determined pixels. There is a mostly-be text pixel 10 in FIG. 7b, which is then smoothed into a text pixel as shown in FIG. 7c. Then, the edge pixels are labeled as the bold label pixels in FIG. 7d. Further, the edge pixels can be labeled as text pixels or background pixels. In this example, the edge pixels are labeled as background (white) pixels whose grayscales are T5 (T5=0×ff), as shown in FIG. 7e. Finally, the text pixels are filled into black pixels whose grayscales are T6 (T6=0), as shown in FIG. 7f. Therefore, the text pixels are turned from gray into black, and having white edge as background. The contrast of the text is enhanced, zigzags are removed, and clearness is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An image enhancement method, applicable to monochrome text image in a digital image, for improving clearness of text, comprising steps of:
labeling text pixels and to-be-determined pixels in said image according to grayscales of image pixels;
searching mostly-be text pixels from said to-be-determined pixels, and smoothing said mostly-be text pixels into text pixels;
searching edge pixels from the rest of said to-be-determined pixels, and filling said edge pixels; and
filling said text pixels.

2. The method according to claim 1 further comprises a step of filling the rest of to-be-determined pixels with background pixels.

3. The method according to claim 1 wherein said step of searching mostly-be text pixels from to-be-determined pixels further comprises steps of:
fetching surrounding adjacent pixels of a to-be-determined pixel;
counting the number of continuous text pixels in said surrounding adjacent pixels; and
determining if said to-be-determined pixel is a mostly-be text pixel according to said counted number.

4. The method according to claim 3 wherein said step of determining a mostly-be text pixel is based on a counted number larger than 5.

5. The method according to claim 1 wherein said step of searching edge pixels from the rest of to-be-determined pixels further comprises steps of:
labeling a target pixel according to grayscale of a to-be-determined pixel;
surrounding said target pixel, defining extending lines in 8 directions;
fetching grayscale values of multiple continuous pixels adjacent to said target pixel in a line of two opposite directions;
determining styles of said multiple continuous adjacent pixels in said two opposite directions according to said grayscales; and
deciding if said target pixel is an edge pixel according to said determination.

6. The method according to claim 5 wherein said step of deciding a target pixel as an edge pixel is based on having multiple continuous adjacent text pixels in one direction of a line and having multiple continuous adjacent background pixels in opposite direction of said line.

7. The method according to claim 5 wherein said step of fetching grayscales of multiple continuous adjacent pixels in a line is to fetch two pixels adjacent to said target pixel in each direction of said line.

8. The method according to claim 1 wherein said step of filling edge pixels is to fill said edge pixels with text pixels.

9. The method according to claim 1 wherein said step of filling edge pixels is to fill said edge pixels with background pixels.

10. The method according to claim 1 wherein said step of filling edge pixels is to fill said edge pixels partially with background pixels and partially with text pixels.
